(19) United States
(12) Patent Application Publication
(10) Pub. No.: US 2015/0231664 A1
(43) Pub. Date: Aug. 20, 2015

(54) SYSTEMS FOR ORIENTING SUBSTRATES DURING MATERIAL APPLICATION PROCESSES

(71) Applicant: HZO, INC., Draper, UT (US)

(72) Inventors: Alexander Crowley, Yarmouth, ME (US); Tyler Child, South Jordan, UT (US); Blake Stevens, Morristown, NJ (US); Jason Maynard, Salt Lake City, UT (US); Steven Bonney, Draper, UT (US); Christopher Shirley, Lehi, UT (US)

(21) Appl. No.: 14/625,474

(22) Filed: Feb. 18, 2015

Related U.S. Application Data
(60) Provisional application No. 61/941,350, filed on Feb. 18, 2014.

(51) Int. Cl. B05C 13/00

(52) U.S. Cl. CPC B05C 13/00

(57) ABSTRACT

Systems for organizing substrates in deposition chambers of material deposition apparatuses are disclosed. Such a system may be configured to organize a large number of substrates (e.g., electronic device subassemblies, such as circuit boards with semiconductor devices and other components secured thereto; partially assembled electronic devices; fully assembled electronic devices; etc.) in a manner that will enable concurrent deposition of material onto all of the substrates of the plurality. The system may be configured to optimize an efficiency with which the substrates are packed into the deposition chamber.

### CROSS-REFERENCE TO RELATED APPLICATIONS

A claim for the benefit of priority to the Feb. 18, 2014 filing date of U.S. Provisional Patent Application 61/941,350, titled TRAYS FOR ORIENTING SUBSTRATES DURING MATERIAL APPLICATION PROCESSES (“the ′350 Provisional Application”), is hereby made pursuant to 35 U.S.C. §119(e). A claim for the benefit of priority to the Aug. 24, 2014 filing date of U.S. Provisional Patent Application 62/041,083, titled RACKS FOR MATERIAL DEPOSITION APPARATUSES (“the ′083 Provisional Application”), is also made pursuant to 35 U.S.C. §119(e). The entire disclosures of the ′350 Provisional Application and the ′083 Provisional Application are hereby incorporated herein.

### TECHNICAL FIELD

This disclosure relates generally to systems for introducing substrates into apparatuses that apply materials to the substrates, or “material application apparatuses,” and, more specifically, to systems for simultaneously introducing pluralities of identical substrates into material application apparatuses. Even more specifically, this disclosure relates to systems for orienting a plurality of substrates non-horizontally to enable material to be applied to exposed surfaces of the substrates.

### SUMMARY

In one aspect, a system is disclosed that is configured to orient a plurality of substrates non-horizontally as a material is applied to the substrates. A substrate support system according to this disclosure, which is also referred to herein as a “system” and as a “tray,” is configured to be used in a deposition chamber of a material deposition apparatus, such as a deposition chamber of an apparatus for depositing protective coatings (e.g., moisture-resistant materials, such as poly(p-xylylene), or parylene; etc.) onto substrates. The system is configured to organize a plurality of substrates (e.g., electronic device subassemblies, such as circuit boards with semiconductor devices and other components secured thereto; partially assembled electronic devices; fully assembled electronic devices; etc.) in a manner that will enable concurrent deposition of material onto all of the substrates of the plurality. The system may be configured to optimize an efficiency with which the substrates are packed into the deposition chamber.

In some embodiments, such a system may include a frame and a plurality of positioners. The frame may be configured to receive the positioners in a plurality of different arrangements, which may enable customization of the system for use with a particular type of substrate. In a specific embodiment, the positioners may comprise elongated positioners, and the frame may be configured to orient the elongated positioners substantially parallel to one another. The frame may have a primary orientation (e.g., horizontal, etc.), and the positioners may be configured to orient substrates transverse (e.g., non-horizontally, etc.) to the primary orientation of the frame.

A frame may have dimensions (e.g., a width, a height, etc.) that enable it to be positioned within a chamber of an apparatus for applying material to one or more substrates. In some embodiments, the frame may be configured to be placed directly within the chamber of the material application apparatus. In other embodiments, the frame may be configured to be assembled with a tray, a rack or another apparatus that, in turn, is configured to be placed within the chamber or to be assembled with another apparatus (e.g., a cart, etc.) that is configured to be placed within the chamber. See, e.g., U.S. Patent Application Publication 2013/0286567 of Sorenson et al. and U.S. Patent Application Publication 2013/0251889 of Cox et al., the entire disclosures of both of which are hereby incorporated herein.

The frame may be configured in a manner that enables the selective arrangement of positioners over the frame. Thus, the frame may include engagement elements that engage corresponding features of positioners of the system. In some embodiments, the engagement elements of the frame and the corresponding features of the positioners may releasably engage one another. In other embodiments, the engagement elements of the frame and the corresponding features of the positioners may permanently engage one another.

A positioner may include a plurality of protruding elements, with receptacles defined between each pair of adjacent protruding elements. In some embodiments, the distance across such a receptacle, or the distance between adjacent protruding elements of a positioner may be the same as or substantially the same as the thickness of a portion of a substrate to be positioned within the receptacle. Thus, the adjacent protruding elements may engage that portion of the substrate by way of an interference fit; i.e., by contacting opposite sides of the portion of the substrate in such a way that the adjacent protruding elements securely hold the portion of the substrate in place within the receptacle. A positioner with adjacent protruding elements that are positioned in such a way is referred to herein as “a retaining positioner.”

In other embodiments of positioners, the distance adjacent protruding elements are spaced apart from one another may exceed the thickness of a portion of a substrate to be positioned between the adjacent protruding elements. Protruding elements that are spaced apart from one another in such a way may hold a portion of a substrate located therebetween in a non-horizontal orientation without engaging the portion of the substrate located between the adjacent protruding elements. Such an arrangement may also prevent adjacent substrates from contacting one another. In embodiments where adjacent protruding elements are spaced a sufficient distance apart from one another, material may be applied to the portion of the substrate located between the adjacent protruding elements. A positioner with protruding elements that do not engage a substrate is referred to herein as a “receiving positioner.”

A set of positioners may be arranged in a manner that enables a plurality of substrates to be arranged adjacent to one another in a series (e.g., in a column, etc.). In some embodiments, such a set may include two or more positioners that are spaced apart a sufficient distance to support the substrates in non-horizontal orientations (e.g., in partially upright orientations, in upright orientations, in substantially vertical orientations, in vertical orientations, etc.). The distance(s) that adjacent positioners are spaced apart from each other may be defined by the frame (e.g., by engagement elements of the frame that engage complementarily configured features of the positioners, etc.). The two or more positioners of a set may be the same (e.g., all retaining positioners, all receiving positioners, etc.) or a plurality of different types of positioners may be used together.

The positioners may be configured to orient substrates in a manner that optimizes the application of material to the substrates. Without limitation, the positioners may be configured to orient substrates in such a way that minimizes obstruction of the flow of material through a chamber, or even in a manner that enhances the way material flows through the chamber. The positioners may orient substrates to maximize the area of the surface of each substrate that is exposed to the material to be applied thereto. Of course, positioners that are configured to provide other advantageous substrate arrangements are also within the scope of the disclosed subject matter.

In other embodiments, a system for organizing substrates may include a stamped sheet of a bendable material (e.g., steel, aluminum, etc.), in which a plurality of positioners are stamped, and selected positioners may be bent into upright orientations. Of course, other positioners may lie flat, and remain unused. All of the positioners of such an embodiment of a system for organizing substrates may be identical to one another. Alternatively, the system may include positioners with two or more different configurations. Selection of the positioners that are bent to upright orientations may be based upon the sizes and/or shapes substrates that are to be introduced into the deposition chamber of a material deposition apparatus, the desired density of and spacing between the substrates and/or any of a variety of other factors.

Less customizable embodiments of systems for organizing substrates within deposition chambers are also disclosed, in which the relative positions of positioners are fixed or substantially fixed relative to one another. The positioners of such a system may be welded, soldered, bolted or otherwise fixed in place relative to one another.

In other embodiments, a system that organizes substrates within a deposition chamber may be configured to hang the substrates in a vertically integrated manner to place the substrates in close proximity to one another. Such a system may also be customizable.

Other aspects of the disclosed subject matter include methods that relate to the disclosed systems. As a few non-limiting examples, methods for arranging positioners on a frame to define a system for carrying a plurality of substrates, methods for using such a system to organize substrates, methods for introducing substrates into an apparatus for used applying material the substrates and methods for applying material to a plurality of substrates are disclosed.

Other aspects, as well as features and advantages of various aspects, of the disclosed subject matter will become apparent to those of ordinary skill in the art though consideration of the ensuing description, the accompanying drawings and the appended claims.

### BRIEF DESCRIPTION OF THE DRAWINGS

In the drawings:

FIGS. 1-3 are perspective views of an embodiment of a system that includes a frame and a plurality of positioners organized on the frame, with FIGS. 1, 2 and 3 showing the positioners in different spacing arrangements;

FIG. 4 provides an end view of an embodiment of elongated member of the frame shown in FIGS. 1-3;

FIG. 4A illustrates another embodiment of an end of a frame that may be used in a system for supporting substrates;

FIG. 5 shows an embodiment of system carrying a plurality of substrates, all of the same type;

FIGS. 6 and 7 are partial orthogonal views of another embodiment of a system for organizing substrates, in which the substrates may hang under force of gravity;

FIGS. 8 and 9 illustrate an embodiment of a base of the system shown in FIGS. 6 and 7;

FIGS. 10 and 11 depict an embodiment of a carrier of the system shown in FIGS. 6 and 7;

FIGS. 12-14 show an embodiment of a system with a pair of positioners whose positions are fixed relative to one another;

FIGS. 15 and 16 illustrate an embodiment of a system that includes a main body with positioners that are configured to be selectively lifted and bent into upright positions for use in supporting substrates; and

FIGS. 17-20 illustrate various embodiments of racks with which systems for organizing substrates may be assembled before a rack and the systems carried thereby are introduced into a deposition chamber of a material deposition apparatus.

### DETAILED DESCRIPTION

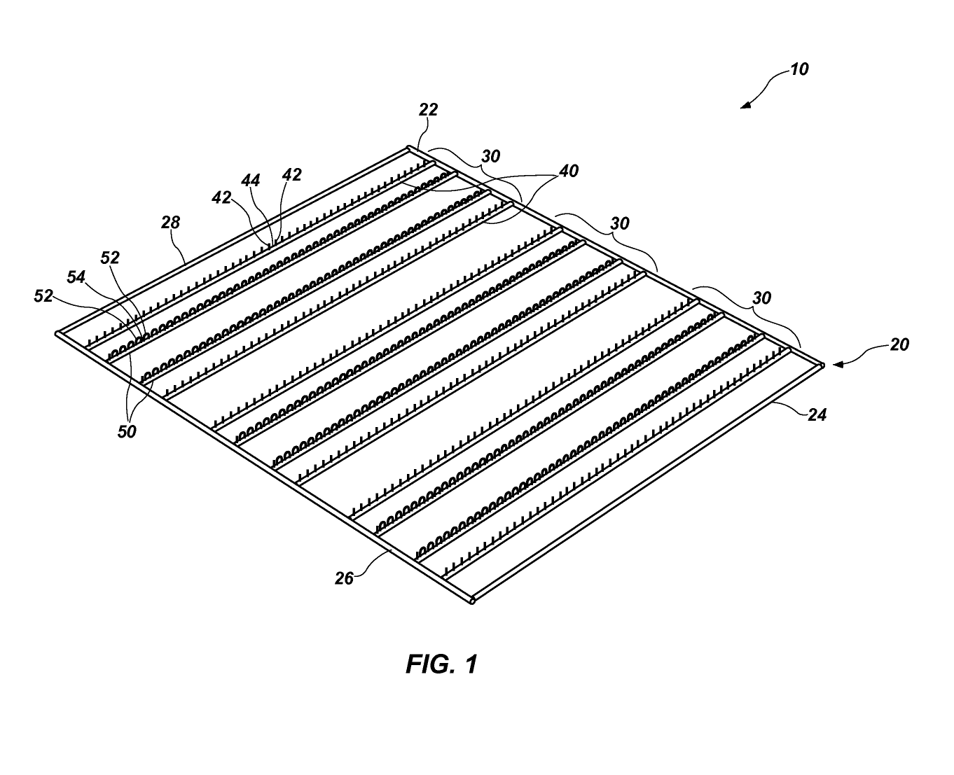

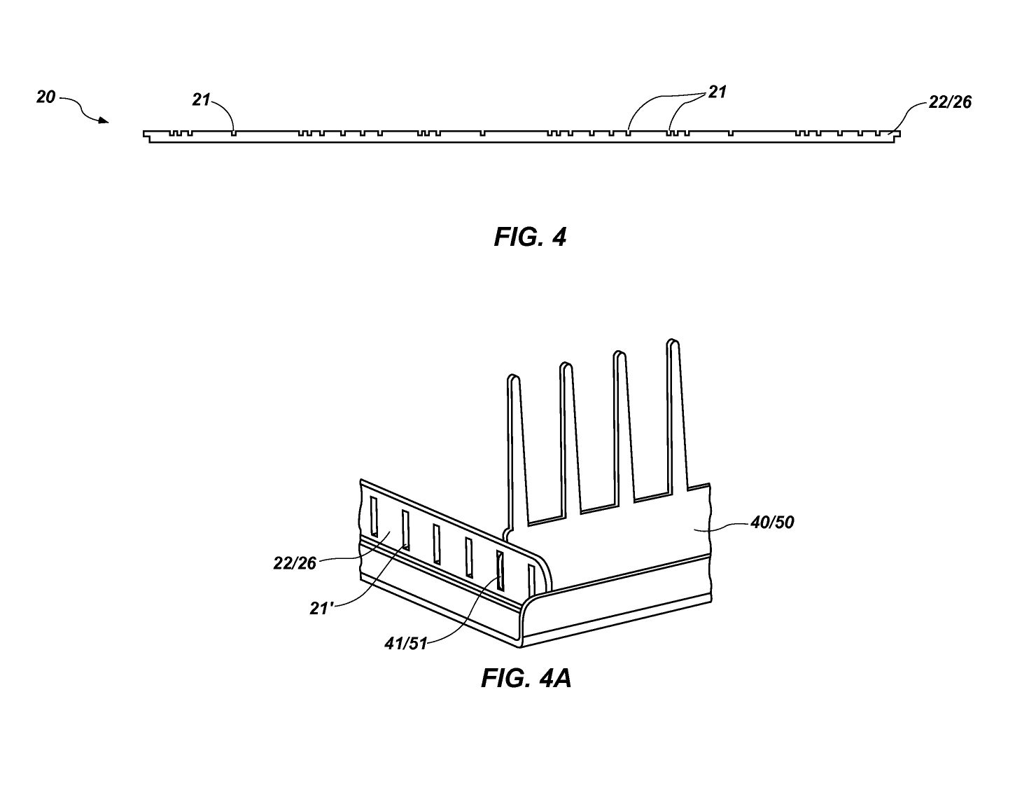

FIGS. 1-5 depict an embodiment of a system 10 for orienting a plurality of substrates 60 (FIG. 5) for the application of a material, such as a protective coating (e.g., a poly(p-xylylene) (i.e., parylene), etc.) thereto. The system 10 includes a frame 20 and a plurality of positioners 40, 50.

In FIGS. 1-3, the frame 20 includes (or consists essentially of or consists of) elongated members 22, 24, 26, 28 that are secured to one another in a manner that defines the lateral extent, or outer periphery of the system 10. Thus, material may pass through the illustrated embodiment of the frame 20. Alternatively a frame may include a planar member, which may include one or more apertures to enable material to pass therethrough, or which may be substantially solid or even solid.

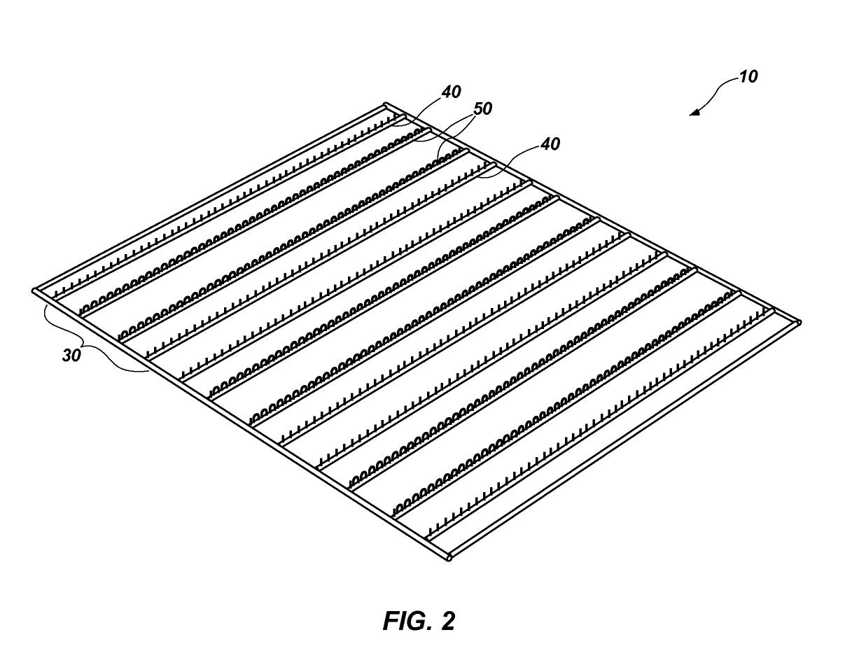

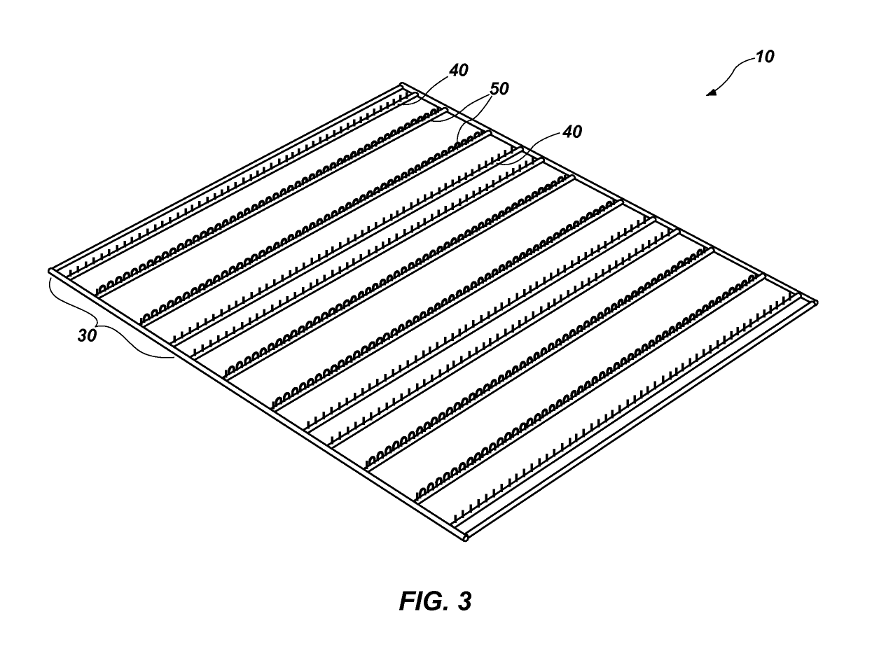

In addition, as shown in FIGS. 4 and 4A, the frame 20 or, more specifically, the elongated elements 22 and 26 of the embodiment of frame 20 shown in FIGS. 1-3, may include engagement elements 21, 21′. In the embodiment shown in FIG. 4, the engagement elements 21 may comprise notches that receive corresponding features (e.g., the bottom edges, complementarily configured notches, etc.) of a positioner 40, 50 (FIG. 1). The engagement elements 21 may enable the elongated elements 22 and 26 and the positioners 40, 50 to be assembled in a variety of different ways, including the arrangements shown in FIGS. 1-3 and in any of a variety of other ways that will become apparent to those of ordinary skill in the art from this disclosure.

In the embodiment depicted by FIG. 4A, the engagement elements 21′ comprise slots in the elongated elements 22 and 26. These slots may be configured to receive the ends 41, 51 or features on the ends 41, 51 (e.g., tabs, etc.) of the positioners 40, 50. The number and positions of the engagement elements 21′ may provide for wide variety in the manner in which the positioners 40, 50 are organized relative to the elongated elements 22 and 26.

Of course, other embodiments of engagement elements are also within the scope of this disclosure.

With returned reference to FIG. 1, a frame 20 may be configured to receive a plurality of sets 30 of positioners 40, 50. More specifically, FIG. 1 depicts an embodiment in which each set 30 includes four positioners 40, 50, with each positioner 40, 50 comprising an elongated element and all of the positioners 40, 50 being arranged parallel to one another. The two outermost positioners 40 comprise receiving positioners and, thus, including protruding elements 42 that are spaced apart from one another sufficient distances to define receiving receptacles 44 that will receive portions of substrates without engaging the substrates. A pair of retaining positioners 50 is located between the receiving positioners 40 of the set 30. Retaining receptacles 54 are defined between adjacent protruding elements 52 of each retaining positioner 50. The protruding elements 52 that define each retaining receptacle 54 are spaced apart a distance that will enable the retaining receptacle 54 to receive a portion of a substrate that is to be held in place by the system 10, while opposed surfaces of the adjacent pair of protruding elements 52 engage surfaces of the portion of the substrate located therebetween to hold the substrate in a non-horizontal orientation.

In FIGS. 2 and 3, arrangements of the system 10 that differ slightly from the arrangement shown in FIG. 1 are shown. In FIG. 2, each receiving positioner 40 and the adjacent retaining positioner 50 of each set 30 are spaced apart a distance that is slightly greater than the spacing between the receiving positioners 40 and their corresponding retaining positioners 50 in the arrangement depicted by FIG. 1. That spacing is even greater in FIG. 3. The different spacing enables the system 10 to accommodate substrates of different dimensions. Without limitation, the arrangement depicted by FIG. 1 may accommodate relatively short substrates, while the arrangement depicted by FIG. 2 may accommodate medium length substrates and the arrangement shown in FIG. 3 may accommodate long substrates.

Of course, other arrangements of positioners 40, 50, are also within the scope of this disclosure. As an example, a single retaining positioner 50 may be placed between two receiving positioners 40. As another example, retaining positioners 50 may be placed at the outside locations of a set 30, with one or more receiving positioners 40 placed therebetween. In other optional arrangements, a retaining positioner 50 may be placed on one side of a set 30, while a receiving positioner 40 may be located at the opposite side of the set 30. In other arrangements, a set 30 may include only receiving positioners 40 or only retaining positioners 50.

FIG. 5 illustrates an embodiment of a system 10 in which three sets 30 of positioners 40, 50 are arranged to hold a plurality of elongated substrates 60 in upright orientations. As illustrated, adjacent substrates 60 are lined up in a spaced-apart fashion, with each set 30 of positioners 40, 50 organizing a plurality of substrates 60 in series; three adjacent columns in the depicted embodiment. The substrates depicted by FIG. 5 are electronic device subassemblies that include components carried by elongated, flexible substrates that have not yet been assembled with housings, input/output features (e.g., display screens, buttons, etc.) or the like.

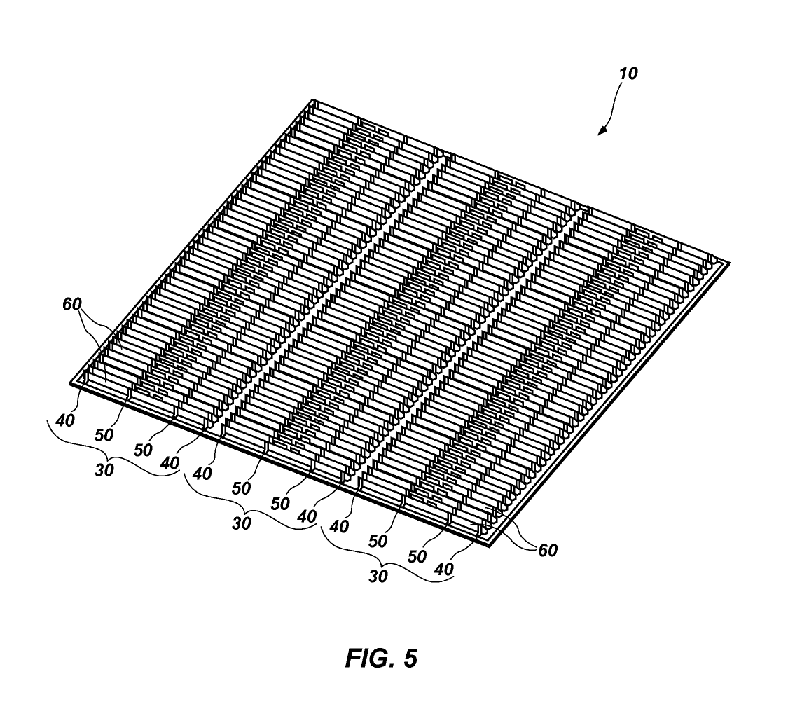

Turning now to FIGS. 6-11, an embodiment of a system 110 is shown that is configured to hang substrates 160 in a vertically integrated manner to position the substrates in close proximity to one another when the system 110 and the substrates 160 are placed within a deposition chamber of a material deposition apparatus.

FIGS. 6 and 7 illustrate an embodiment of a system 110 that is configured to carry a plurality of substrates 160. The system 110 includes an embodiment of a frame that is referred to herein as a “base 120” and an embodiment of positioner that is referred to herein as a “carrier 130.” The carrier 130 is configured to hang the substrates 160. More specifically, the carrier 130 may include a plurality of hanging posts 134, which may be configured to be received by apertures, slots, recesses or other features of the substrates 160 and to enable the substrates 160 to hang under force of gravity. The carrier 130 may also include a plurality of support posts 135, each of which may be configured to receive or otherwise engage another portion of a substrate 160 to prevent the substrate 160 from swinging as it hangs from one or more hanging posts 134.

The system 110 may be configured to carry the substrates 160 so that substantially all of their surfaces are exposed (e.g., other than those portions of the substrates 160 that contact a hanging post 134, a support post 135 or another portion of the system 110, etc.). In some embodiments, the system 110 may be configured to organize substrates 160 in such a way that they are placed adjacent to one another, or juxtaposed, in parallel relation to one another.

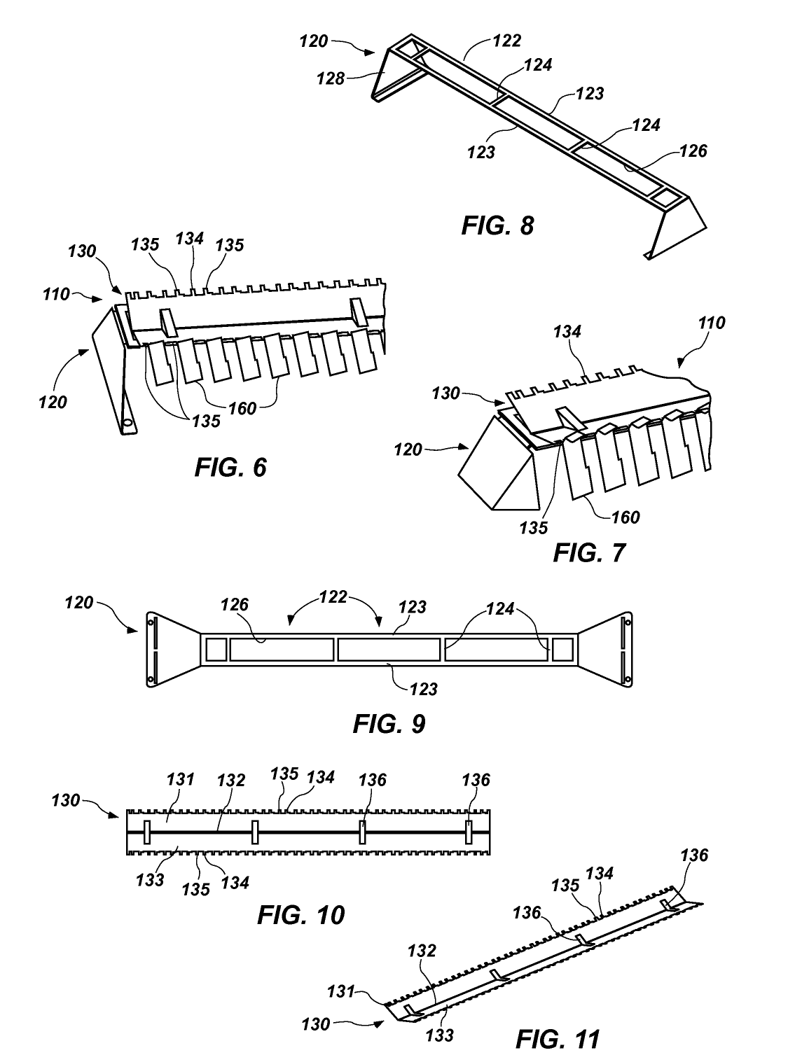

FIGS. 8 and 9 show an embodiment of the base 120 of the system 110 shown in FIGS. 6 and 7. The base 120 may be configured to be positioned on a tray or a rack that may be positioned within a deposition chamber of a material deposition apparatus, such as an apparatus that is configured to deposit parylene or other materials onto one or more substrates 160 (FIGS. 6 and 7). In the illustrated embodiment, the base 120 includes a central member 122 and feet 128 at opposite sides or ends of the central member 122. The central member 122 may be configured to support one or more carriers 130 of the system 110, while the feet 128 may be configured to elevate the central member 122 and any carrier(s) 130 (FIGS. 6 and 7) thereon to a height above a surface on which the feet 128 rest to enable substrates 160 (FIGS. 6 and 7) to hang freely.

In the specific embodiment depicted by FIGS. 8 and 9, the central member 122 of the base 120 may comprise an elongated member with a pair of spaced apart side elements 123. In addition, one or more transverse elements 124 may extend across a width of the central member 122, or transverse to a length of the central member 122. The embodiment of base 120 depicted by FIGS. 8 and 9 includes a central member 122 with four transverse elements 124.

The side elements 123 and any transverse elements 124 of the central member 122 of the base 120 may define one or more receptacles 126 in the central member 122. Each receptacle 126 may be configured to receive and a carrier 130 (FIGS. 6, 7, 10 and 11) or a portion thereof, and to support the carrier 130 and any substrates 160 (FIGS. 6 and 7) hanging therefrom. As illustrated by FIGS. 6 and 7, the receptacles 126 may receive a majority of a carrier 130. In some embodiments, the receptacle(s) 126 may be configured to receive any of a variety of different configurations of carriers 130; e.g., carriers 130 that are configured to arrange substrates 160 in different ways or carriers 130 that are configured to hold different configurations of substrates 160.

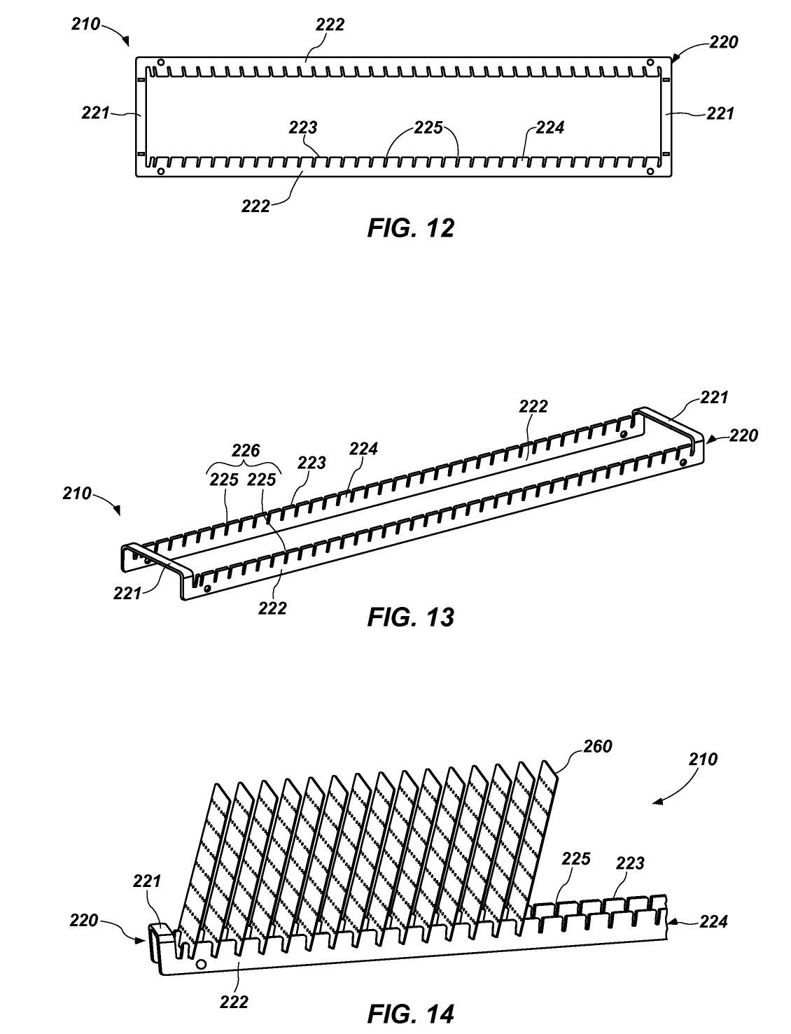

FIGS. 10 and 11 illustrate an embodiment of a carrier 130 that may be used with the base 120 shown in FIGS. 8 and 9. The carrier 130 may include two side elements 131 and 133 that meet at a central location 132. The central location 132 and the side elements 131 and 133 may extend along the length of the carrier 130. The side elements 131 and 133 may be configured to rest upon side edges of a receptacle 126 (FIGS. 8 and 9) of the base 120 of the system 110. The side elements 131 and 133 may diverge from one another, or be arranged relative to one another, at the central location 132, at an angle of less than 180°. The angle at which the side elements 131 and 133 are arranged may enable substrates 160 (FIGS. 6 and 7) to be placed in a deposition chamber of a material deposition apparatus with a desired packing efficiency (e.g., number of substrates per volume, etc.). In some embodiments, the carrier 130 may be configured in such a way that the angle between its side elements 131 and 133 may be adjusted.

The hanging posts 134 and the support posts 135 protrude from outer edges of the side elements 131 and 133 of the carrier 130. Each hanging post 134 may be configured to be received by an aperture in a substrate 160 (FIGS. 6 and 7) and may, therefore, carry the substrate 160, such as a circuit board or a subassembly of an electronic device, without contacting any of its major surfaces (e.g., its top surface, its bottom surface, etc.). The support posts 135 may be similarly configured, and may merely make contact with a small portion, or point, of an edge of a substrate 160.

In embodiments of the system 110 where the base 120 (FIGS. 6-9) includes one or more transverse elements 124 (FIGS. 6-9), the carrier 130 may include a corresponding number of transverse slots 136. Each transverse slot 136 may be configured to receive a transverse element of the base 120, as shown in FIGS. 6 and 7. Accordingly, each transverse slot 136 may extend across the central location 132 of the carrier 130, and into central portions of each side element 131 and 133 of the carrier 130. The transverse slots 136 of the carrier 130 and the transverse elements 124 of the base 120 may be configured to cooperate with one another in a manner that enables proper positioning of the carrier 130 relative to the base 120 and/or in a manner that stabilizes the carrier 130 and any substrates 160 (FIGS. 6 and 7) hanging therefrom.

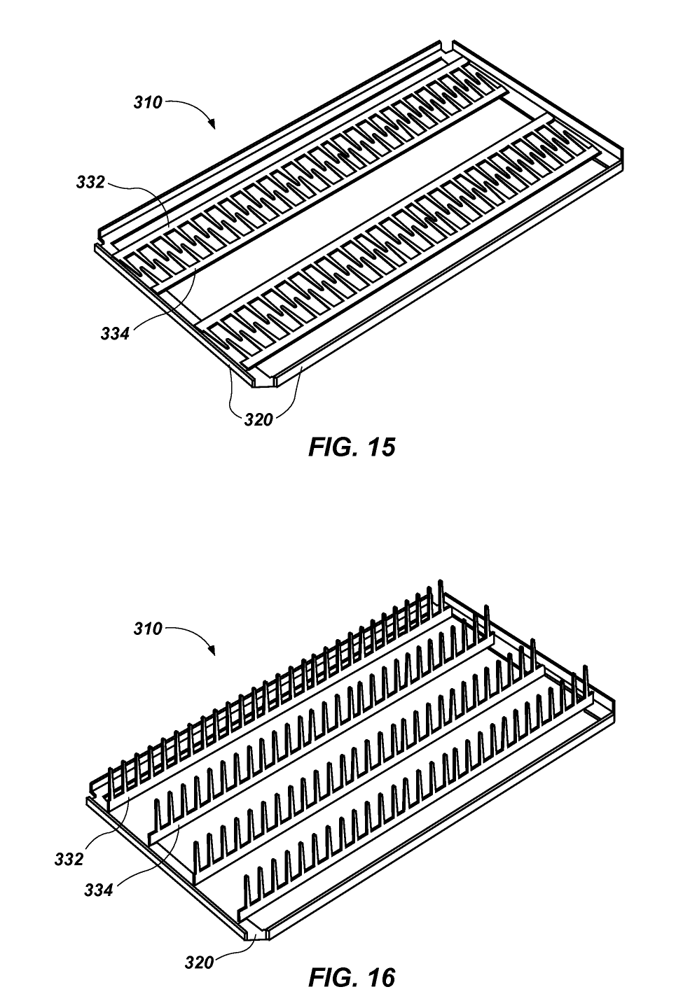

Another embodiment of system 210 for organizing substrates 260 is depicted by FIGS. 12-14. The system 210 shown in FIGS. 12-14 is configured to orient a plurality of substrates 160 in upright orientations. The system 210 includes a base 220 with a pair of positioners, which are referred to as “side elements 222,” that may be oriented parallel to one another and at least one cross member 221 extending between the side elements 222 to hold the side elements 222 in place relative to one another.

Each side element 222 may include a plurality of notches 225 defined in its upper edge 223. The notches 225 may extend downward into an upper portion 224 of the side elements 222. Each notch 225 may be configured to hold a corresponding portion of a substrate 260 in a manner that will enable the substrate 260 to be oriented in a non-horizontal or upright orientation while making minimal contact with the substrate 260.

Each corresponding pair of notches 225 (e.g., notches 225 that are aligned, side-to-side, etc.) may define a slot 226. Each slot 226 is (and the notches 225 that define that slot 226 are) configured to receive an edge of a substrate 260, such as the circuit board of an electronic subassembly, and to collectively support the substrate 260. The slots 226 may be configured, positioned and oriented to arrange the substrates 260 in a desired manner. As illustrated by FIGS. 12-14, the slots 226 may be configured, positioned and oriented to arranged the substrates 260 in upright orientations, parallel and adjacent to one another. In addition, since the notches 225 are configured to establish minimal contact with the surfaces of the substrate 260, the slots 226 may enable exposure of substantially all surfaces of the substrate 260.

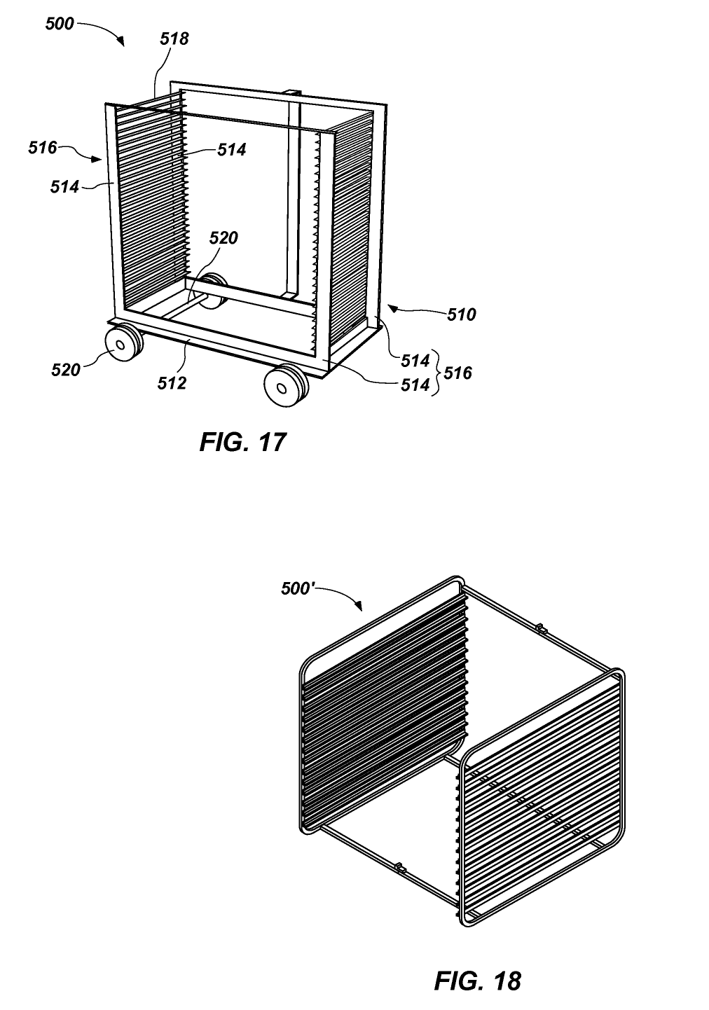

FIGS. 15 and 16 illustrate an embodiment of system 310 for arranging or organizing substrates (not shown) onto which a material is to be deposited. In FIG. 15, the system 310 is in a flat orientation. As illustrated, the system 310 includes a main body 320 with a plurality of positioners 332, 334 that have been cut, or punched, from the main body 320. All of the positioners 332, 334 of the system 320 may have the same configuration as one another or, as illustrated, the system may include two or more different configurations of positioners 332, 334.

The material from which the system 310 is formed may enable the positioners 332, 334 to be selectively lifted, or bent, to raised orientations, as shown in FIG. 16. Without limitation, the system may be formed from a metal or a metal alloy (e.g., a steel, etc.). Selection of the positioners 332, 334 that are to be lifted may be based on the size(s) and/or configuration(s) of substrates that are to be supported (e.g., in non-horizontal or at least partially upright orientations, etc.), the desired spacing between adjacent substrates, the orientations in which the substrates are to be supported and/or any of a variety of other factors.

A system for organizing substrates according to this disclosure may be made from any of a variety of suitable materials. As indicated previously, a bendable material, such as a metal or a metal alloy may be used to form some embodiments of systems, or at least some of the elements thereof.

The material from which a system or its elements is formed may comprise an electrostatic discharge or electrostatic dissipative (ESD) material. ESD materials are configured not to collect static electricity and, therefore, may prevent the potentially damaging discharge of static electricity onto or into the substrates that they may carry. Thus, the use of ESD materials in systems according to this disclosure may prevent damage to sensitive electronic devices and their components. Examples of ESD materials include, but are not limited to, a variety of plastics.

In some embodiments, the material(s) from which the elements of a system of this disclosure are formed may enable the system to be made inexpensively. As an example, the embodiment of system 10 illustrated by FIGS. 1-5 and described in reference to those drawings may comprise elements (e.g., elongated members 22, 24, 26, 28; positioners 40, 50) that are made by injection molding processes. The use of plastics to form these elements may enable them to be snapped together in a desired arrangement. Such a disposable system may be used once or a few times (e.g., until material build-up becomes undesirably thick, etc.), and then discarded.

In other embodiments, a system according to this disclosure may be made from a material that is more suited for permanent use. Such a material may withstand repeated cycles of use (e.g., material deposition, etc.) and cleaning (e.g., removal of material buildup by mechanical processes and/or chemical processes, etc.), as well as preventative maintenance on the system or any of its elements.

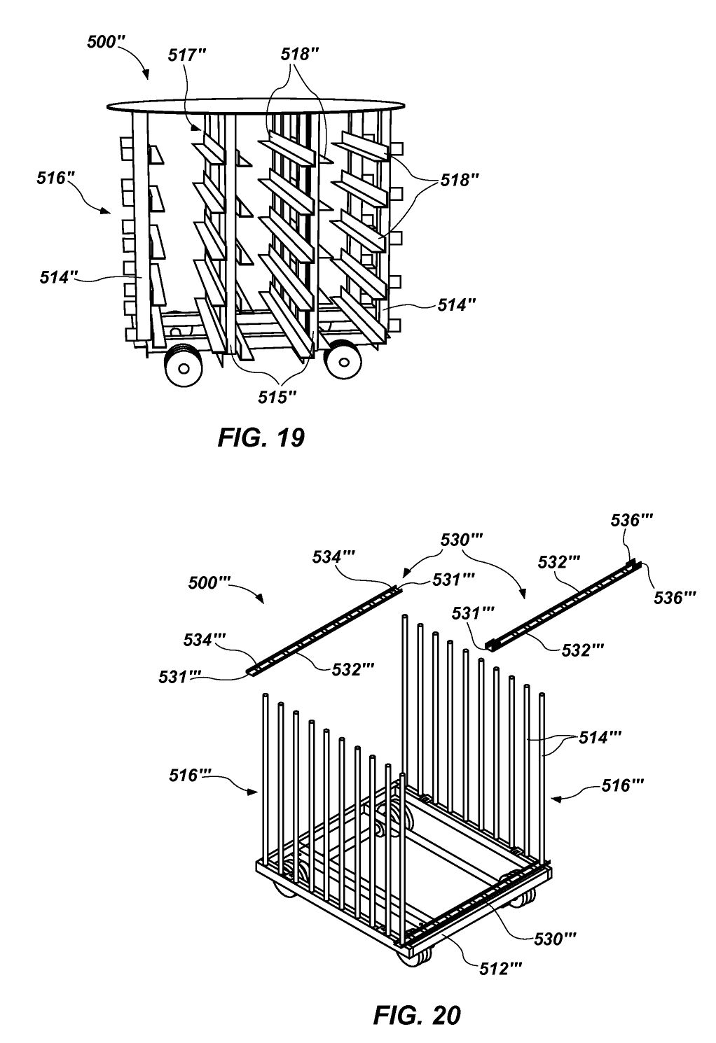

As indicated previously herein, a system according to this disclosure (e.g., system 10, 110, 210, 310, etc.) may be introduced directly into a deposition chamber of a material deposition apparatus, or it may be assembled with a rack. FIGS. 17-20 illustrate various non-limiting embodiments of racks.

The rack 500 of FIG. 17 includes a frame 510 with a base 512 and a plurality of upright elements 514 that extend vertically from the base 512. Adjacent pairs of upright elements 514 form ends 516 of the frame 510. Horizontal elements 518 extend across each end 516 of the frame 510, from one upright element 514a to the other upright element 514b at that end 516. Each horizontal element 518 may extend laterally toward an interior of the frame 510, which may enable that horizontal element 518 to support an edge of a system, or a tray, for arranging a plurality of substrates. Accordingly, a corresponding pair of horizontal elements 518, which may be located on opposite ends 516 of the frame 510, may be configured to completely support a tray that has been introduced in a horizontal orientation or in a somewhat horizontal orientation between the ends 516 of the frame 10. In the depicted embodiment, the frame 510 includes a plurality of corresponding pairs of horizontal elements 518; which may enable a plurality of trays to be stacked on and carried by the frame 510.

In addition to the frame 510, the rack 500 shown in FIG. 17 includes a pair of axles 520 associated with the base 512 of the frame 510 and wheels 522 at the ends of the axles 520.

The rack 500′ shown in FIG. 18 is configured similarly to the rack 500 of FIG. 17, but lacks axles 520 and wheels 522.

FIG. 19 illustrates an embodiment of a rack 500″ that includes a frame 510″ with a base 512″ and upright elements 514″ that define ends 516″ of the frame 510″. In addition, the frame 510″ includes a plurality of intermediate upright elements 515″, which may be positioned between the upright elements 514″ and are positioned between the ends 516″ of the frame 510″. One or more groups 517″ of intermediate upright elements 515″ may be arranged linearly and, in some embodiments, each group 517″ may be oriented parallel to an end 516″ of the frame 510″.

Each group 517″ of intermediate upright elements 515″ may carry a plurality of horizontal elements 518″, and these horizontal elements 518″ may extend laterally from both sides of the intermediate upright elements 515″. Each horizontal element 518″ may be positioned at an elevation along the upright elements 515″ that corresponds to an elevation of an opposed horizontal element 518″ on an adjacent end 516″ of the frame 510″ or on an adjacent group 517″ of intermediate upright elements 515″ of the frame 510″. Such an arrangement may enable a corresponding pair of horizontal elements 518″ to support a tray. In addition, such an arrangement may enable two or more trays to be supported at a same elevation of the frame 510″.

FIG. 20 depicts an embodiment of rack 500′″ with a frame 510′″ that includes a base 512′″ and a plurality of upright elements 514′″, or posts, that extend upwardly from opposite sides of the base 512′″ and that define ends 516′″ of the frame 510′″. In the depicted embodiment, each end 516′″ includes a series of upright elements 514′″. Corresponding pairs 517′″ of upright elements 514′″ are located on opposite ends 516′″ of the frame 510′″ from one another. Each corresponding pair 517′″ of upright elements 514′″ may be configured for assembly with one or more rails 530′″ of the rack 500′″.

Each rail 530′″ may comprise an elongated element with an aperture 534′″ adjacent to each of its ends 531′″. Each aperture 534′″ may be configured to receive an upright element 514′″. At opposite sides of each aperture 534′″, and on opposite sides 532′″ of the rail 530″, the rail 530′″ may include tabs 536′″ that are oriented to engage the upright element 514′″ that extends through each aperture 534′″ in a manner that will maintain a vertical position of the rail 530′″ along the height of the vertical element 514′″ under the weight of the rail 530′″ and under the weights of any substrates (not shown) that are at least partially carried by the rail 530′″. At intermediate locations 537′″, each rail 530′″ may include a plurality of substrate engagement features 538′″, which may be configured to receive an edge of a substrate (e.g., a printed circuit board, etc.). In some embodiments, a substrate may be held in place simply by positioning two rails 530′″ apart from one another by a distance that is slightly less than a corresponding dimension across the substrate, in which case opposite edges of the substrate may abut against and be held in place between the sides 532′″ of the adjacent rails 530′″.

Such an embodiment of cart 500′″ allows for customization in the heights at which rails 530′″ may be positioned, the vertical spacing between two adjacent rails 530′″ and the lateral spacing between two adjacent rails 530′″. Thus, the height and/or width of each receptacle of the cart 500′″ may be customized.

Although the foregoing disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

What is claimed:

1. A system for introducing a plurality of identical items into a deposition chamber of a material deposition apparatus, comprising:
a frame configured to receive a plurality of positioners in substantially parallel arrangement, the frame having a primary orientation defined by a length and a width of the frame; and
the plurality of positioners, each including a plurality of protruding elements with receptacles defined between adjacent pairs of the plurality of protruding elements, each receptacle of the receptacles configured to receive a portion of a substrate while minimizing contact with the substrate, each adjacent pair of protruding elements configured to orient the portion of the substrate transversely to a primary orientation of the frame.

2. The system of claim 1, wherein the frame is configured to receive the plurality of positioners in a plurality of arrangements.

3. The system of claim 2, wherein the frame is configured to enable adjacent positioners of the plurality of positioners to be selectively spaced a plurality of different distances apart from one another.

4. The system of claim 1, wherein the plurality of positioners includes at least one set of positioners for arranging a plurality of substrates parallel to one another.

5. The system of claim 4, wherein the at least one set of positioners includes at least one retaining positioner with adjacent pairs of protruding elements configured to engage portions of substrates.

6. The system of claim 5, wherein an adjacent pair of protruding elements of the at least one retaining positioner is spaced apart by a distance that is substantially the same as a thickness of a portion of a substrate to be engaged between the adjacent pair of protruding elements.

7. The system of claim 6, wherein the adjacent pair of protruding elements of the at least one retaining positioner is spaced apart by a distance that is the same as the thickness of the portion of the substrate to be engaged between the adjacent pair of protruding elements.

8. The system of claim 5, wherein the at least one set of positioners includes at least one receiving positioner with adjacent pairs of protruding elements configured to receive portions of substrates to orient the portions of the substrates while enabling application of material to the portions of the substrates between the adjacent pairs of protruding elements.

9. The system of claim 8, comprising at least one retaining positioner between a pair of receiving positioners.

10. The system of claim 9, comprising a pair of retaining positioners between the pair of receiving positioners.

11. The system of claim 10, wherein the pair of receiving positioners are spaced apart a distance corresponding to lengths of the substrates to be oriented by the at least one set of positioners.

12. The system of claim 1, wherein the frame is configured to enable at least some positioners of the plurality of positioners to be selectively arranged relative to other positioners of the plurality of positioners.

13. The system of claim 12, wherein the frame is configured to enable selective spacing of adjacent positioners of the plurality of positioners a plurality of distances apart from one another.

14. The system of claim 12, wherein the frame is configured to enable selective arrangement of a plurality of types of positioners of the plurality of positioners relative to one another.

15. A system for introducing a plurality of identical items into a deposition chamber of a material deposition apparatus, comprising:
a frame configured to carry at least one positioner at an elevation that enables a plurality of substrates to hang in non-horizontal orientations; and
the at least one positioner, comprising a plurality of elements configured to carry the plurality of substrates in the non-horizontal orientations without contacting major surfaces of the plurality of substrates.

16. The system of claim 15, wherein the at least one positioner is configured to orient the plurality of substrates parallel to one another.

17. The system of claim 15, wherein the frame includes a horizontally oriented central member upon which the at least one positioner is configured to rest, the horizontally oriented central member including at least one receptacle for receiving a majority of the at least one positioner.

16. A cart including a plurality of receptacles, each receptacle of the plurality of receptacles configured to receive a system for organizing a plurality of substrates in non-horizontal orientations.

17. The cart of claim 16, wherein the plurality of receptacles are superimposed relative to one another.

18. The cart of claim 16, wherein the height of each receptacle is customizable.

19. The cart of claim 16, wherein the width of each receptacle is customizable.

20. A material deposition apparatus, including a deposition chamber configured to apply a protective coating to a plurality of substrates, the deposition chamber configured to receive:
a plurality of systems for organizing substrates in non-horizontal orientations; and
a cart for organizing the systems in superimposed relation to one another.

21. The material deposition apparatus of claim 20, configured to deposit a parylene coating on the plurality of substrates.
